(19) United States
(12) Patent Application Publication
(10) Pub. No.: US 2026/0052186 A1
(43) Pub. Date: Feb. 19, 2026

(54) NETWORK BANDWIDTH CONSERVATION VIA EDGE AND PEER SOFTWARE TRANSFER

(71) Applicant: AT&T Intellectual Property I, L.P., Atlanta, GA (US)

(72) Inventors: Nigel Bradley, Canton, GA (US); Walter Cooper Chastain, Atlanta, GA (US); Sheldon Kent Meredith, Roswell, GA (US); Zhi Cui, Sugar Hill, GA (US)

(73) Assignee: AT&T Intellectual Property I, L.P., Atlanta, GA (US)

(21) Appl. No.: 18/804,690

(22) Filed: Aug. 14, 2024

(51) Int. Cl. H04L 67/00; G06F 8/65; H04L 67/12

(52) U.S. Cl. CPC H04L 67/34; G06F 8/65; H04L 67/12

(57) ABSTRACT

Aspects of the subject disclosure may include, for example, software content being distributed from an edge network node in a communications network to a first vehicle. The first vehicle may provide the software content to other vehicles with or without further involvement by the communications network. The vehicles may be part of a group and/or may form an ad hoc group. Other embodiments are disclosed.

### FIELD OF THE DISCLOSURE

The subject disclosure relates to software content distribution.

### BACKGROUND

Communications networks are generally capable of distributing software. For example, end user devices typically download software from communications networks. Communication bandwidth is typically consumed for each software download.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A and 2B are block diagrams illustrating example, non-limiting embodiments of a communications network communicating with vehicle(s) in accordance with various aspects described herein.

FIG. 2C is a block diagram illustrating an example, non-limiting embodiment of a communications network communicating with a vehicle groups database in accordance with various aspects described herein.

FIG. 2D is a block diagram illustrating an example, non-limiting embodiment of a vehicle broadcasting a need to a communications network in accordance with various aspects described herein.

FIG. 2E is a block diagram illustrating an example, non-limiting embodiment of a vehicle broadcasting needs to other vehicles in accordance with various aspects described herein.

FIG. 2F is a block diagram illustrating an example, non-limiting embodiment of a vehicle broadcasting assets to other vehicles in accordance with various aspects described herein.

FIGS. 2G and 2H are block diagrams illustrating example, non-limiting embodiments of secure content distribution between a communications network and vehicles in accordance with various aspects described herein.

FIGS. 2I and 2J are block diagrams illustrating example, non-limiting embodiments of vehicles joining an ad hoc group in accordance with various aspects described herein.

FIG. 2K is a block diagram illustrating an example, non-limiting embodiment of a vehicle offloading communications network transport in accordance with various aspects described herein.

FIGS. 2L-2N depict illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for content distribution among peers. Other embodiments are described in the subject disclosure.

Various embodiments described herein enable distribution of software content among a defined group of vehicles. The various embodiments use edge networking and vehicle-to-vehicle communication between vehicles to transfer the content. The group of vehicles may be, for example, a fleet, or other set of vehicles, serving an associated purpose. The groups may be defined in advance or created ad hoc. The content may be software such as app software, operating system software, media, and other types of content that has commonly useful purposes.

One or more aspects of the subject disclosure include a device, comprising a processing system including a processor; and a memory that stores executable instructions that, when executed by the processing system, facilitate performance of operations. The operations may include receiving a first software content; sending the first software content to a first vehicle; receiving a request for the first software content from a second vehicle; and alerting the second vehicle that the first software content is available from the first vehicle.

Additional aspects of the subject disclosure include positioning the first software content at an edge node of a communications network based on a location of the first vehicle, positioning the first software content at an edge node of a communications network based on a historical demand from a plurality of vehicles, determining that the first vehicle and the second vehicle are members of a first group or fleet and positioning the first software content at an edge node based on a future location of vehicles in the first group or fleet, and determining that the first vehicle and the second vehicle have a trusted relationship, and wherein the alerting the second vehicle that the first software content is available from the first vehicle is in response to the determining that the first vehicle and the second vehicle have the trusted relationship.

One or more aspects of the subject disclosure include a non-transitory machine-readable medium, comprising executable instructions that, when executed by a processing system including a processor, facilitate performance of operations. The operations may include receiving, at a first vehicle, software from a communications network; receiving, at the first vehicle, a first request for the software from a second vehicle; and providing the software from the first vehicle to the second vehicle.

Additional aspects of the subject disclosure include receiving the software from an edge node in the communications network, determining that the first vehicle and the second vehicle are in a common group, broadcasting to additional vehicles in a vicinity of the first vehicle, an availability of the software at the first vehicle, and providing the software from the first vehicle to a non-vehicular device for further distribution.

Additional aspects of the subject disclosure include first vehicle having a route known to the communications network and wherein the receiving the software from the communications network comprises receiving the software from a network node along the route; receiving, at the first vehicle, a second request for the software from a third vehicle; determining that the third vehicle is not in a common group with the first vehicle; determining that the third vehicle has a trusted relationship with the second vehicle; and responsive to the determining that the third vehicle has the trusted relationship with the second vehicle, providing the software from the first vehicle to the third vehicle; and the determining that the third vehicle has the trusted relationship with the second vehicle comprising receiving, from the second vehicle, an indication of the trusted relationship.

Additional aspects of the subject disclosure include the determining that the third vehicle has the trusted relationship with the second vehicle comprising receiving, from the communications network, an indication of the trusted relationship; determining that the first vehicle and the second vehicle are not in a common group; and forming an ad hoc group including the first vehicle and the second vehicle.

One or more aspects of the subject disclosure include a method, comprising: storing, by a processing system including a processor, a first vehicle ID corresponding to a first vehicle and a second vehicle ID corresponding to a second vehicle in a record of a vehicle group database, wherein the record defines a first vehicle group; receiving, by the processing system, a software content to be provided to vehicles in the first vehicle group; sending, by the processing system, the software content to the first vehicle; and sending, by the processing system, to the second vehicle, an indication of availability of the software content at the first vehicle.

Additional aspects of the subject disclosure include determining, by the processing system, a route of the first vehicle; and pre-positioning, by the processing system, the software content at a network node along the route of the first vehicle; receiving, by the processing system, a request for the software content from a third vehicle not in the first vehicle group; determining, by the processing system, that the first vehicle and the third vehicle have a trusted relationship; and providing, by the processing system, the software content to the third vehicle; wherein the determining that the first vehicle and the third vehicle have the trusted relationship comprises retrieving information from a vehicle trusted relationships database.

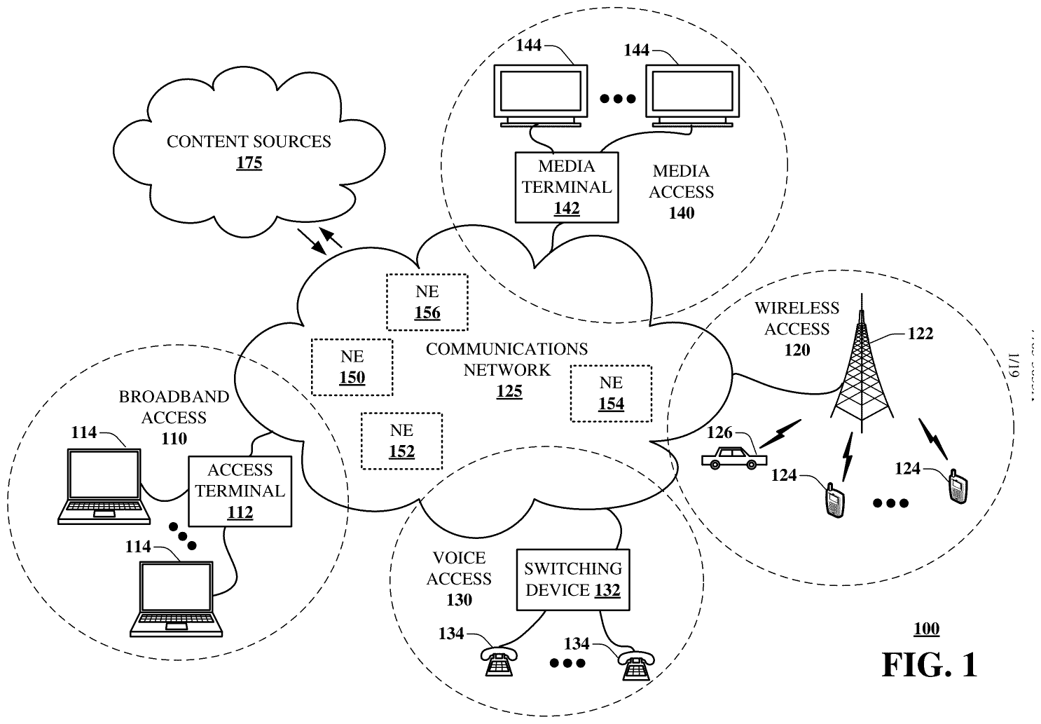

Referring now to FIG. 1, a block diagram is shown illustrating an example, non-limiting embodiment of a system 100 in accordance with various aspects described herein. For example, system 100 can facilitate in whole or in part content distribution among peers. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 3G, 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 3G, 4G, 5G, or higher generation modem, an optical modem and/or other access devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In various embodiments, the base station or access point 122 provides communication services to mobile devices 124 and vehicles 126 and can include a 3G, 4G, 5G, or higher generation base station, an access point that operates via an 802.11 standard such as 802.11n, 802.11ac or other wireless access terminal. In some embodiments, wireless access is provided by one or more satellites. For example, communications network 125 may communicate with one or more geosynchronous or low earth orbit (LEO) satellites that communicate with mobile devices 124 and/or vehicles 126. The mobile devices 124 can include mobile phones, e-readers, tablets, phablets, wireless modems, and/or other mobile computing devices. Vehicles 126 may include any type of vehicle (e.g., cars, trucks, airplanes, trains, ships, etc.).

In some embodiments, base station 122 provides software content to vehicles 126, and vehicles 126 may distribute the software content between each other, thereby offloading bandwidth requirements from the base station 122 and communications network 125. These and other embodiments are further described below.

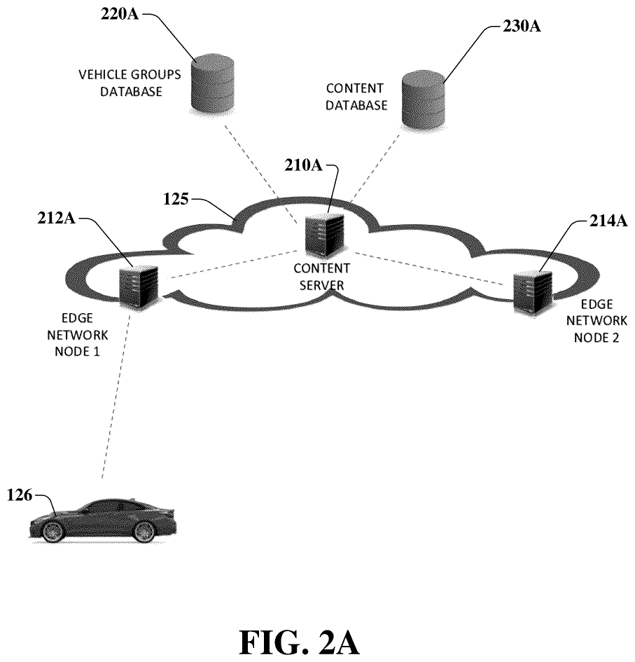

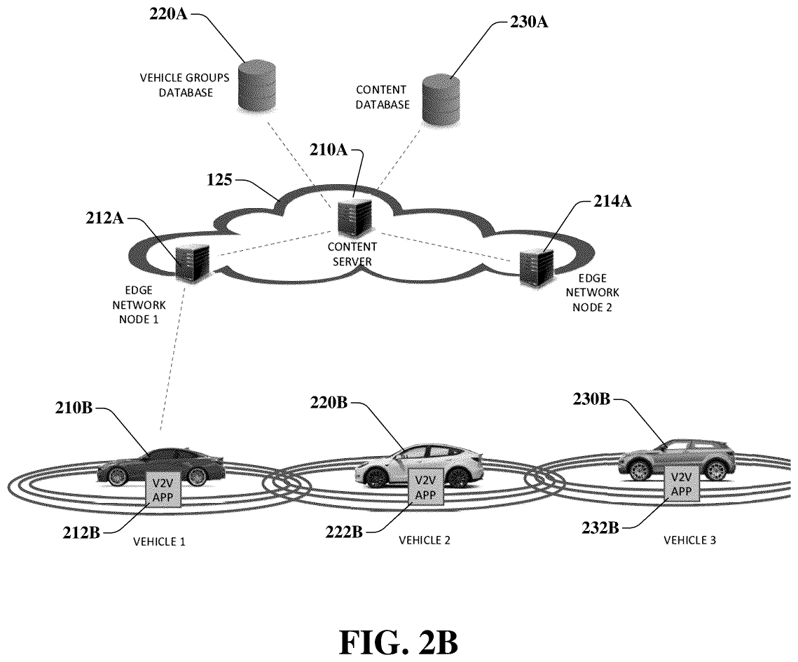

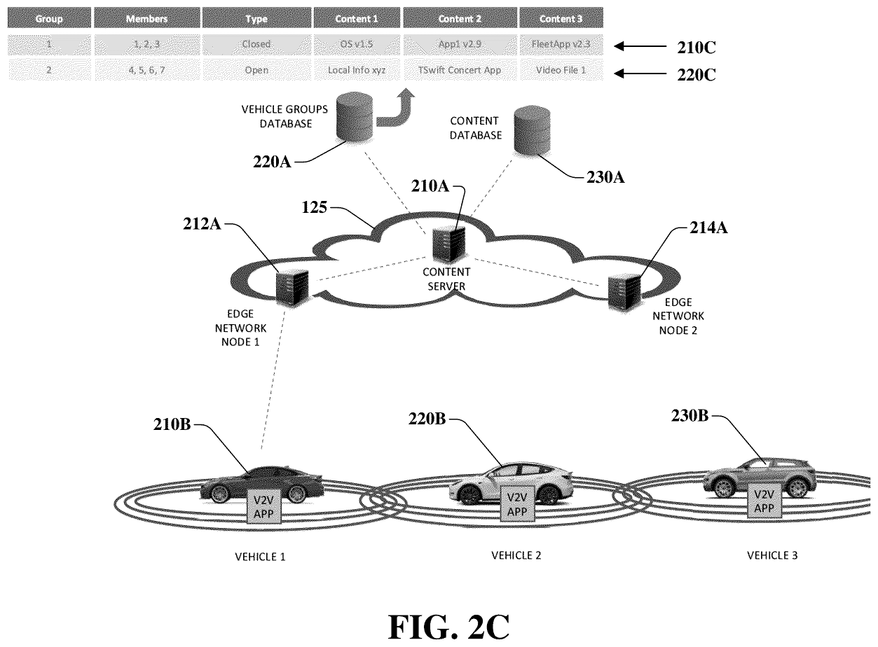

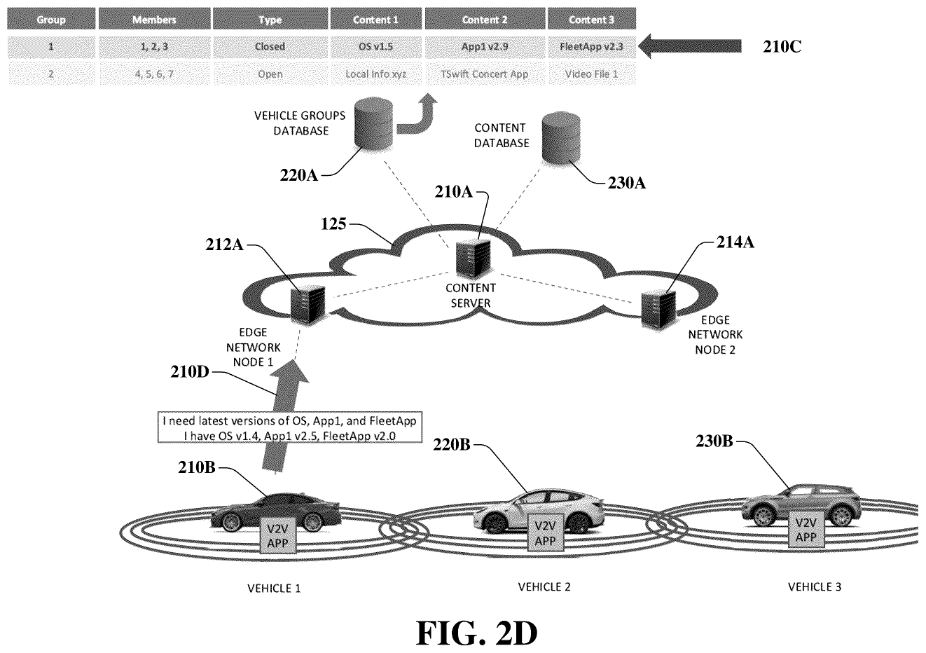

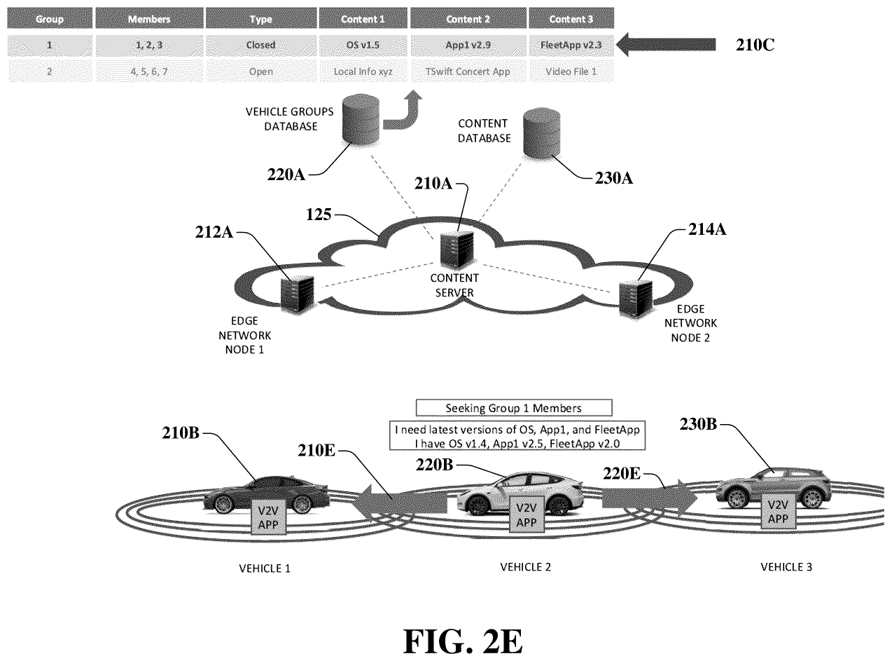

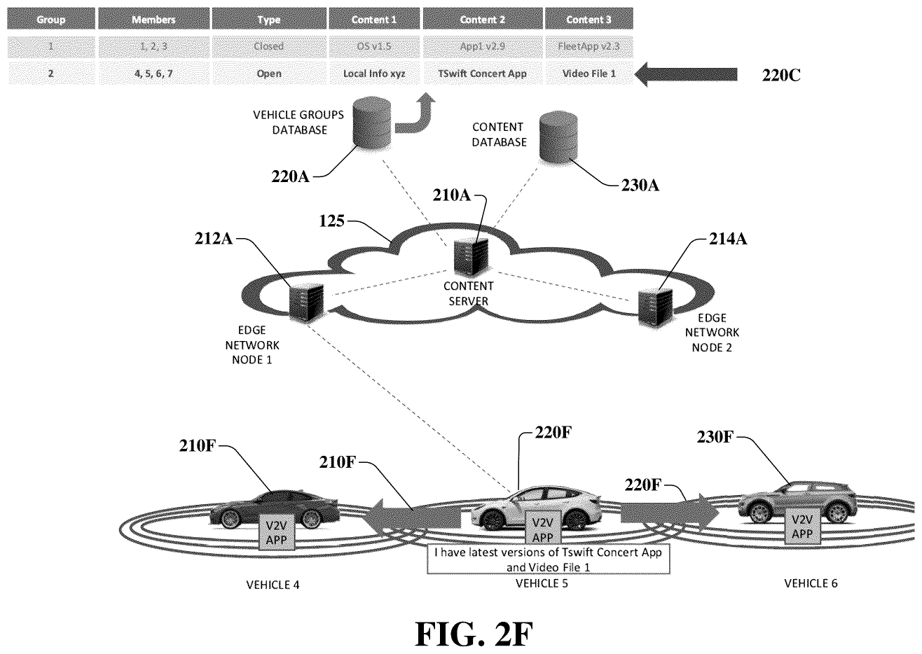

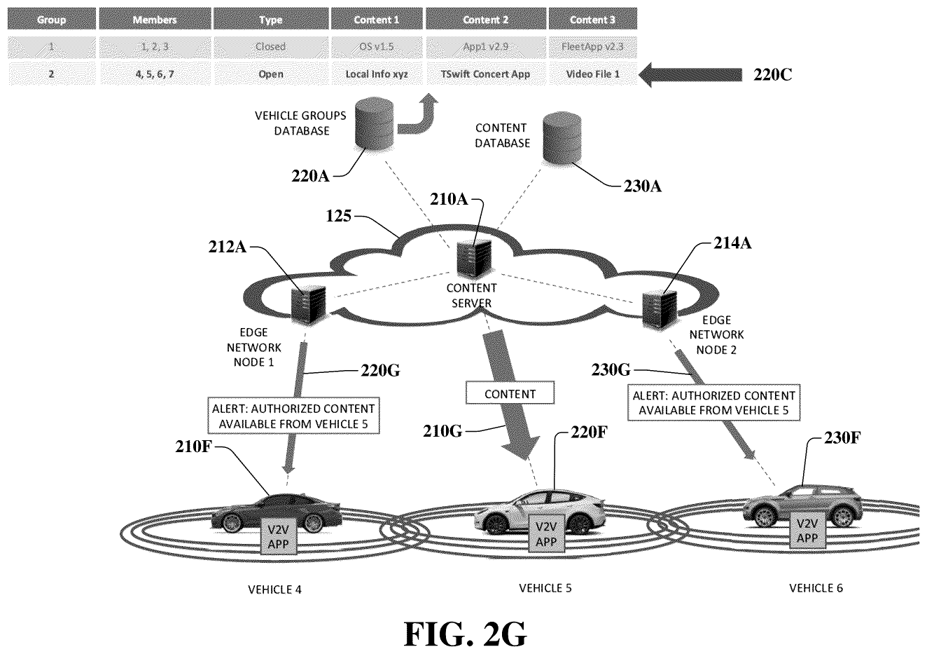

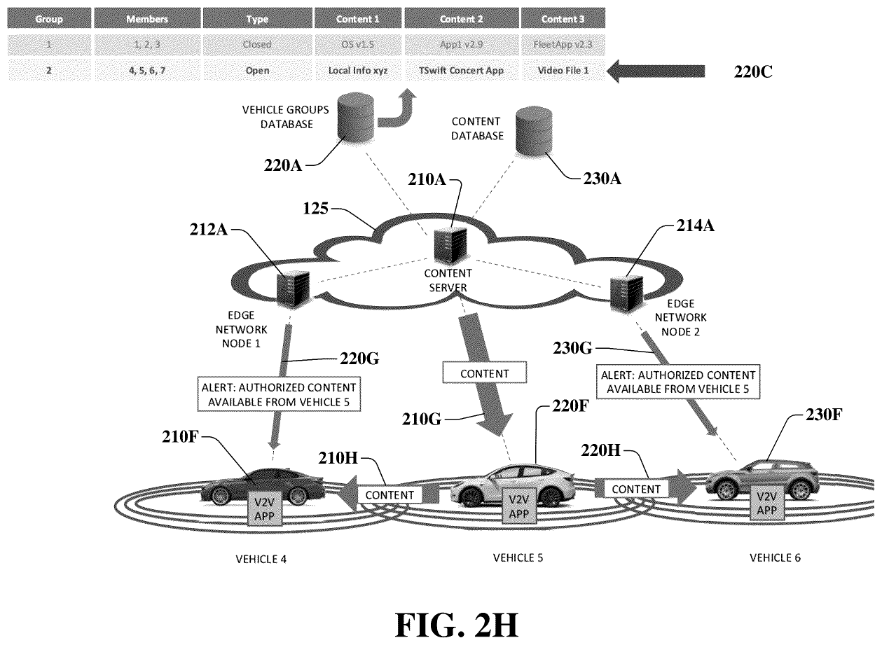

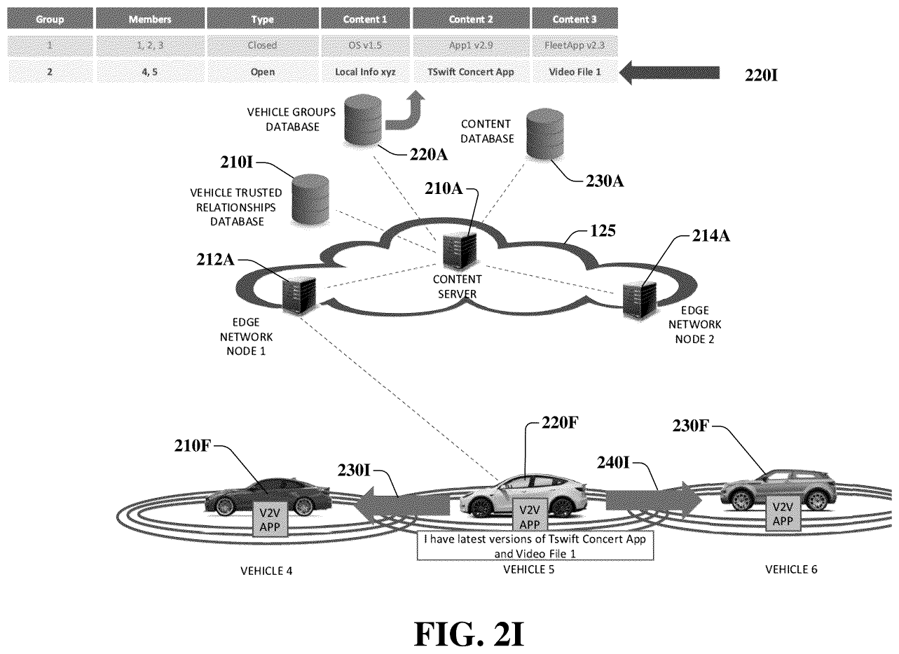

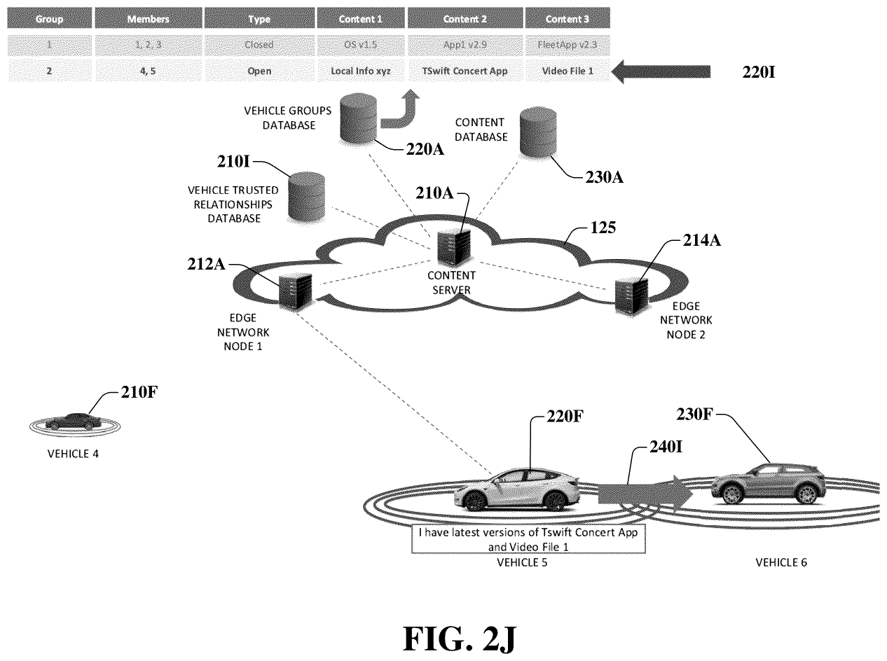

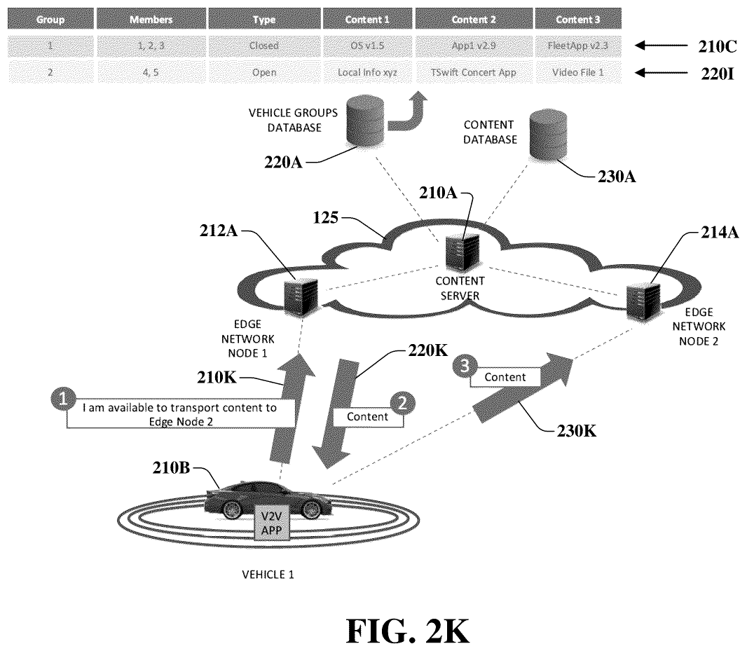

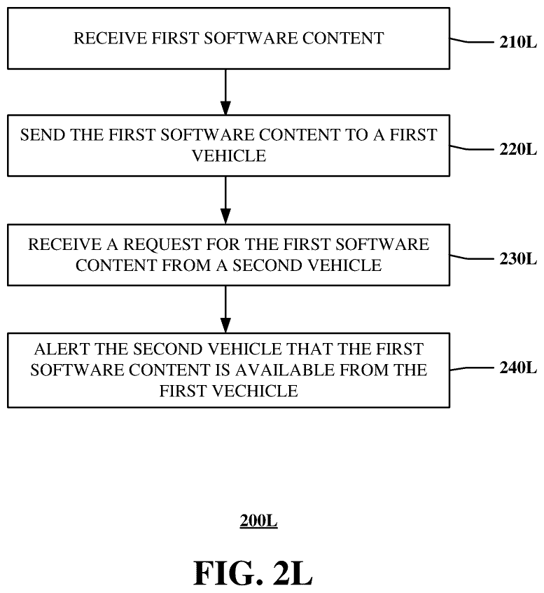

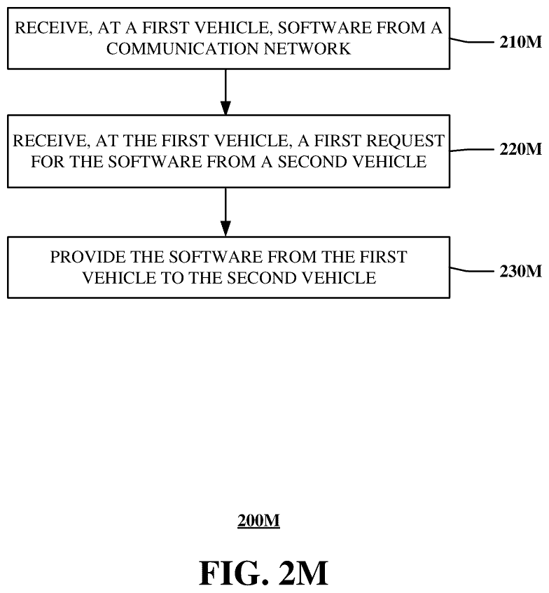

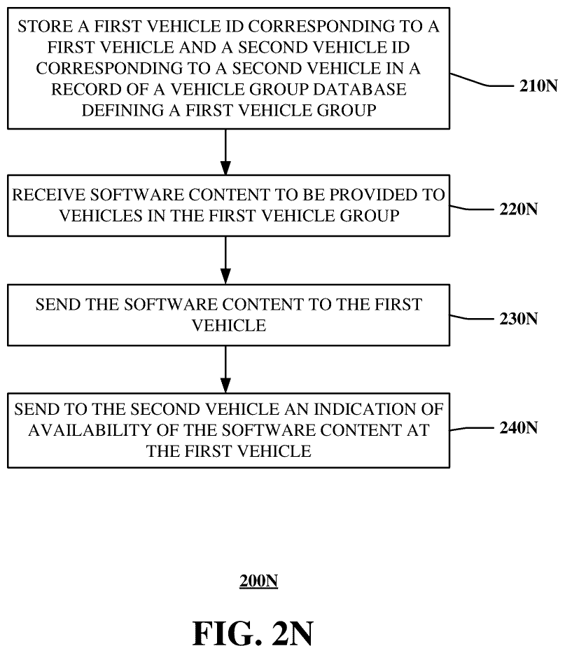

FIGS. 2A and 2B are block diagrams illustrating example, non-limiting embodiments of a communications network communicating with vehicle(s) in accordance with various aspects described herein. FIG. 2A shows communications network 125 having content server 210A, edge network node 212A (edge network node 1) and edge network node 214A (edge network node 2). FIG. 2A also shows vehicle groups database 220A, content database 230A and vehicle 126.

Vehicle 126 may be equipped with wireless capabilities that allow it to connect with among other things one or more edge network nodes (e.g., edge network node 1, edge network node 2, etc.). The edge network nodes may be in communication over communications network 125 with content server 210A, which can also communicate with vehicle groups database 220A and content database 230A.

The content database 230A may act as a repository of any number of different types of software content. This content may include, but is not limited to, operating system software, application software, server software, vehicle management software (e.g., engine management software, airbag management software, etc.), media content such as video, audio, and other types of media, and data such as engine management data (e.g., data commonly uploaded to vehicles via onboard diagnostic tools “OBDII”). In some embodiments, the content may be a software update that is distributed as a result of a recall. For example, the content may an airbag software update that is distributed to vehicles as a result of a recall.

The software content may also be content that has temporal or spatial relevance such as detailed content that is related to a place and time, or the occurrence of an event or a milestone at a place in time geographically, such as detailed navigation data for a location, or content related to a concert or other event at a known place and time. For example, the software content may be destined for a driverless vehicle that the vehicle needs to process only within a specific area.

As shown in FIG. 2B, in some embodiments, there may also exist other vehicles with similar capabilities to vehicle 126. FIG. 2B shows vehicles 210B (vehicle 1), vehicle 220B (vehicle 2), and vehicle 230B (vehicle 3). All or some of the vehicles may also have vehicle-to-vehicle communication capabilities, such that they can communicate with other vehicles without engaging a network to do so. For example, vehicle 1 includes V2V app 212B, vehicle 2 includes V2V app 222B, and vehicle 3 includes V2V app 232B. In some embodiments, these vehicle-to-vehicle communication capabilities may use standard known communication protocols, with additional elements and functions as described in this disclosure.

As the vehicles traverse a geographic area, they may connect with one or more of the edge network nodes that are within a location range of the vehicle. For example, as illustrated in FIG. 2B, vehicle 1 may connect to edge network node 1 when within range. Also for example, as illustrated in FIG. 2B, vehicles 2 and 3 may not connect to an edge network node when not in range.

FIG. 2C is a block diagram illustrating an example, non-limiting embodiment of a communications network communicating with a vehicle groups database in accordance with various aspects described herein. FIG. 2C shows example contents of vehicle groups database 220A. The example contents include two records 210C and 220C, where each record defines a vehicle group.

One or more vehicle groups may be defined. A vehicle group is a set of vehicles that have common needs or interests of the vehicles and/or their occupants. The groups may be either closed or open. Closed groups are those that only allow for the content for each group to be provided to members of the group. Open groups allow for public sharing of content that is available to the group. For example, a closed group may be a group in which all of the vehicles are members of a service fleet, and therefore would typically require the same type of content software content on each vehicle member of the fleet. Open groups may be groups that allow for wider sharing of publicly available content. In some embodiments, open groups may also require ad hoc joining as described further below.

The vehicle groups database may store records for each group including member ID's, and content that is pertinent to each group. For example, as shown in FIG. 2C, record 210C defines closed group 1 with members 1, 2, 3, and software content OS v1.5, Appl v2.9, and FleetApp v2.3. Also for example, as shown in FIG. 2C, record 220C defines open group 2 with members 4, 5, 6, 7, and software content Local Info xyz, TSwift Concert App, and Video File 1.

Groups 1 and 2 shown in FIG. 2C have non-overlapping membership, however the various embodiments are not limited in this manner. For example, in some embodiments, member 3 may be a fleet vehicle that is part of closed group 1 and may also be part of open group 2. Also for example, a vehicle may be a member of one group, and user devices (e.g., mobile phones) within the vehicles may be members of different groups.

In some embodiments, group definitions may be statically defined (e.g., fleets with fixed membership), or may be dynamic (e.g., situationally, geographically, or time dependent), such as when a particular vehicle or other entity is inside of a defined polygon or geofenced area, or when particular devices or vehicles are only members of a group during a certain time on a certain day (e.g., Tuesdays from 2:00 to 4:00 PM).

In some embodiments, the group definitions within vehicle groups database 220A may include authentication information. For example, members of a particular group may need to satisfy one or more levels of authentication prior to receiving software content. In some embodiments, a person in a vehicle may authenticate by scanning a badge on a user device within the vehicle. For example, the vehicle group definition may enforce a rule that requires an employee of a business to authenticate using an RFID badge before downloading a file. In some embodiments, the authentication level may be dependent on the type of download. For example, downloading a performance tune file for a vehicle may require the owner of the vehicle to authenticate.

FIG. 2D is a block diagram illustrating an example, non-limiting embodiment of a vehicle broadcasting a need to a communications network in accordance with various aspects described herein.

In some embodiments, as a vehicle traverses an area, it may broadcast its needs for any software content. If the vehicle is within range of an edge network node, the edge network node may provide any necessary content or updates to content. For example, as shown in FIG. 2D, vehicle 1 (as a member of group 1), may broadcast its need for latest versions of OS, App1, and FleetApp. It may include in the broadcast that it currently has versions v1.4 of OS, v2.5 of App1, and v2.0 of FleetApp.

The edge network node may communicate with a content server and determine that the vehicle is a member of group 1, and the content server may provide any needed content via edge network node 1 to vehicle 1.

FIG. 2E is a block diagram illustrating an example, non-limiting embodiment of a vehicle broadcasting needs to other vehicles in accordance with various aspects described herein.

In some embodiments, when a vehicle is not in range of an edge network node, the vehicle may broadcast its needs to other vehicles. For example, as shown in FIG. 2E, vehicle 2, which is not in communication with an edge network node, broadcasts its needs to vehicle 1 at 210E and to vehicle 3 at 220E. In some embodiments, vehicle 2 may send out a vehicle-to-vehicle broadcast message first to seek to identify any other vehicles that are within range that are also members of the group as vehicle 2. Therefore, vehicle 2 may include in its broadcast an identification of the group ID for which it is seeking communication of content.

Other vehicles may respond to the broadcast of needs of vehicle 2 by either communicating a response back to vehicle 2 that includes the requested content or may reply to vehicle 2 with an indication that vehicle 2 has the most current content available for Group 1. Note that this vehicle-to-vehicle solution may be accomplished without using network resources since the vehicles may collectively establish an understanding of what content or current version of content is available on board the collective fleet of vehicles.

FIG. 2F is a block diagram illustrating an example, non-limiting embodiment of a vehicle broadcasting assets to other vehicles in accordance with various aspects described herein. FIG. 2F show vehicle 210F (vehicle 4), vehicle 220F (vehicle 5), and vehicle 230F (vehicle 6).

In some embodiments, a vehicle may first acquire content over a network, such as via a content server or an edge network node. In the example of FIG. 2F, vehicle 5 connects to edge network node 1 as a member of group 2 and retrieves the latest versions of TSwift Concert App and Video File 1. Vehicle 5 may subsequently issue a vehicle-to-vehicle broadcast message (shown at 210F and 220F) advertising that it has the content and offer to share it with other vehicles. In the case of content that is related to open groups, this content sharing may be done with other vehicles that are not explicitly members of a group. For example, if vehicle 4 requests vehicle 5 to share content that vehicle 5 has advertised as being available, vehicle 5 may send the content to vehicle 4 while within range for a vehicle-to-vehicle transfer.

In some embodiments, vehicle 4 may monitor the transfer of the content for completeness. For example, if the transfer of content was incomplete while in range for vehicle-to-vehicle communications, vehicle 4 may make a record in its vehicle-to-vehicle app of the incomplete transfer including a record of what portion of the content was received by vehicle 4. Accordingly, vehicle 4 may later request transmission of the remainder of the content from another vehicle or edge network node when within range.

In some embodiments, a vehicle may prioritize content to broadcast based on any criteria. For example, in some embodiments, a vehicle may prioritize which content to broadcast based on historical demand. Also for example, in some embodiments, a vehicle may prioritize which content to broadcast based on what is known to be available, either at the vehicle or at an edge network node. In still further example, an edge network node may command a vehicle to prioritize certain contents to prioritize when broadcasting.

FIGS. 2G and 2H are block diagrams illustrating example, non-limiting embodiments of secure content distribution between a communications network and vehicles in accordance with various aspects described herein.

Various embodiments not only provide for content distribution but may also securely manage the content distribution. For example, the content may be delivered to vehicle 5 at 210G, which may act as a content distribution node vehicle. The content server may in turn notify other vehicles of vehicle 5's availability as an authorized distributor of the content.

Optionally, an alert may be presented to the occupants of vehicles 4 and 6 at 220G and 230G to indicate the availability of the content nearby. In these embodiments, the alert may be delivered via an authorized app, but the content itself may be delivered via vehicle-to-vehicle communication (shown at 210H and 220H). In some embodiments, an occupant may be required to approve the distribution of the content to the occupant's vehicle prior to the software content being distributed to the vehicle. For example, an occupant may be presented with an approval screen on a mobile device or may be presented with a checksum that can be validated against a checksum displayed in the vehicle prior to the vehicle receiving the software content. Also in some embodiments, the authorization may take place in the V2V app in the occupant's mobile phone without the occupant's interaction.

FIGS. 2I and 2J are block diagrams illustrating example, non-limiting embodiments of vehicles joining an ad hoc group in accordance with various aspects described herein.

In some embodiments, a vehicle may have a trusted relationship with another vehicle, such that this relationship enables ad hoc group joining for the purpose of accessing content. For example, vehicles 4 and 5 are members of a group defined by record 2201 and vehicle 6 is not a member of the group. However, vehicle 6 may have a trusted relationship with vehicle 4 that enables vehicle 4 to vouch for vehicle 6 to allow it to temporarily join the group. If all of the vehicles are within a common proximity, this vouching may be conducted via vehicle-to-vehicle communications.

In some embodiments, these trusted relationships may be maintained in a vehicle trusted relationships database 210I. During the vouching process, an edge network node may consult the vehicle trusted relationships database 210I in order to allow vehicle 6 temporary membership in the group.

If vehicle 4 is out of range for vehicle-to-vehicle communications as shown in FIG. 2J, the trusted relationship may be stored in trusted relationships database 210I, such that when vehicle 6 requests the content provided by vehicle 5, vehicle 5 may consult with trusted vehicle relationships database 210I to determine that vehicle 4 and vehicle 6 have a trusted relationship.

In some embodiments, software content is positioned or pre-positioned at one or more edge network nodes based on various criteria. For example, software content may be pre-positioned at edge network nodes for which there is likely to be a higher demand for content access at that location. In one specific example, when vehicle 5 shares content with vehicle 4 using vehicle-to-vehicle communications, a report of the transaction, including the location at which the transaction occurred, may be sent to the edge network node and content server. As a result, the content server can track over time where there are higher volume locations where vehicle-to-vehicle content sharing occurs for specific types of content or specific content itself. Therefore, the content server may pre-position pertinent content at edge network node 1 if, over time, trends indicate that the specific content of note is more likely to be in demand for access at a location near edge network node 1.

In a similar manner, the content server may be provided with access to predetermined routes for vehicles that are members of a group, for instance, a fleet. Accordingly, if the content server knows that fleet vehicles will be more likely traversing locations near edge network node 1, the content server may preposition content there.

In some embodiments, a mobile edge network node may be deployed. This may be for example, a drone or other vehicle (cell on wheels, or COW) that may temporarily be positioned along areas of a route that are expected to be highly traversed by members of the vehicle group.

In some embodiments, a fleet of vehicles may have a known route. In these embodiments, software content may be prepositioned at edge network nodes along the known route for software content distribution later in the day.

FIG. 2K is a block diagram illustrating an example, non-limiting embodiment of a vehicle offloading communications network transport in accordance with various aspects described herein.

In some embodiments, membership in a group may also provide a vehicle with proxy authentication to serve as a transport for software content from one edge network node to another. As an example, vehicle 1 may inform edge network node 1 that it is available to transport content related to Group 1 at 210K. Available destinations for transport of the software content may be determined based on any criteria, including for example, a planned route for a fleet vehicle.

As a result, edge network node 1 may provide a response to vehicle 1 that authorizes vehicle 1 to distribute the content at 220K. Vehicle 1 may distribute content to other vehicles along the way as described above. In addition, vehicle 1 may also distribute the content to edge network node 2, therefore alleviating the network from using its resources to move content from edge network node 1 to edge network node 2.

The transport vehicle (vehicle 1 in this example) may distribute the software content to any node, including nodes within the communications network (e.g., edge network nodes) and also including nodes not within the communications network (e.g., an isolated, nonconnected storage node in a rural location, or a connected node outside the communication network). When the transport vehicle distributes the software content to a remote node, the content may be available to other vehicles that are in the vicinity of that remote node. Examples include, but are not limited to, a storage node at a fleet service garage, a storage node on a remote island frequently by bush planes, and the like.

In some embodiments, each node that provides information to any other entity connected to the node can keep a history of movement of software content at that node and allow inquiries into that history for duly authorized entities. The authorized entities are then able to know which vehicles have visited this node and received this particular information or update.

In some embodiments, a mesh connectivity is provided by remote nodes that are not directly connected to the network, and this mesh connectivity may be used to provide information back to the communications network by proxy. For example, a plane may fly into a remote community to deliver packages and the plane is an entity that updates a node in the community. Over time, a number of additional planes may fly into the community. These additional planes may or may not receive the software content from the node. The node that sits in the remote community knows through its history which of the additional planes received the software content, and then when a particular plane flies in it, it can query that information. And then when the particular plane gets back within vicinity of an edge network node, it may upload the history and then the network can be aware which of the additional planes flying into the remote community have been updated, and which have not.

FIG. 2L depicts illustrative embodiments of methods in accordance with various aspects described herein. Method 200L may be performed by a device, system, or subsystem involved in software content distribution. For example, in some embodiments, method 200L may be performed by a content server, an edge network node, a network element within a communications network, or the like.

At 210L, first software content is received. In some embodiments, this may correspond to an edge network node receiving the first software content from a content server or a content database. The first software content may be any type of digital file, including executable software, media content, configuration information, or the like. In some embodiments, the first software content is received as a result of pre-positioning the first software content in a communications network. For example, the first software content may be intended for use by a fleet of vehicles having a known route, and the first software content may be received by an edge network node along the route. Also for example, the first software content may be pre-positioned based on a historical demand for the software content by one or more vehicles.

At 220L, the first software content is sent to a first vehicle. In some embodiments, the first vehicle requests the first software content prior to the first software content being sent to the first vehicle. For example, a first vehicle may broadcast a need for updated software or other digital content, and in response the software content may be sent to the first vehicle.

At 230L, a request for the first software content is received from a second vehicle. The second vehicle may be in a group with the first vehicle. For example, a record in a vehicle groups database may show that the first vehicle and the second vehicle are in a common group.

At 240L, the second vehicle is alerted that the first software content is available from the first vehicle. In some embodiments, this is performed in response to determining that the first vehicle and the second vehicle are in a common group. In some embodiments, this is performed in response to determining that the first vehicle and the second vehicle have a trusted relationship. In still further embodiments, the first software content may be positioned at an edge node based on a future location of vehicles in a fleet in response to determining that the first vehicle and the second vehicle are members of the first fleet.

FIG. 2M depicts illustrative embodiments of methods in accordance with various aspects described herein. Method 200M may be performed by a device, system, or subsystem involved in software content distribution. For example, in some embodiments, method 200M may be performed by a vehicle, a device within a vehicle, or the like.

At 210M, software is received at a first vehicle from a communications

network. In some embodiments, this may correspond to vehicle 1 receiving software from an edge network node as shown in FIG. 2C. At 220M, the first vehicle receives a request for the software from a second vehicle. In some embodiments, this corresponds to vehicle 1 receiving a request broadcast by vehicle 2 as shown in FIG. 2E.

At 230M, the software is provided from the first vehicle to the second vehicle. In some embodiments, this corresponds to the first vehicle sending the software to the second vehicle without involving the communications network. In other embodiments, this corresponds to the first vehicle determining that the second vehicle is trusted. For example, the first vehicle may have a trusted relationship with a third vehicle, and the first vehicle may determine that the third vehicle has a trusted relationship with the second vehicle. In still further embodiments, the first vehicle may request that the communications network consult a trusted relationship database to determine that the second vehicle is to be trusted.

In some embodiments, the first vehicle determines that the first vehicle and the second vehicle are in a common group and the sending the software to the second vehicle is in response to the determining that the first vehicle and the second vehicle are in a common group.

In some embodiments, the first vehicle determines that the first vehicle and the second vehicle are not in a common group, and the first vehicle and the second vehicle form an ad hoc group prior to the first vehicle sending the software to the second vehicle.

In some embodiments, the first vehicle broadcasts to additional vehicles in a vicinity of the first vehicle, an availability of the software at the first vehicle. In still further embodiments, the first vehicle provides the software from the first vehicle to a non-vehicular device for further distribution. For example, the first vehicle may provide the software to a node in a remote area or in an area frequented by other vehicles. Examples include those described above with reference to planes arriving at remote locations as well as fleet garages.

FIG. 2N depicts illustrative embodiments of methods in accordance with various aspects described herein. Method 200N may be performed by a device, system, or subsystem involved in software content distribution. For example, in some embodiments, method 200N may be performed by a content server, an edge network node, a network element within a communications network, or the like.

At 210N, a first vehicle ID corresponding to a first vehicle and a second vehicle ID corresponding to a second vehicle are stored in a record of a vehicle group database defining a first vehicle group. In some embodiments this corresponds to populating a record within vehicle groups database 220A. For example, IDs for vehicle 1 and vehicle 2 may be stored in record 210C of vehicle groups database 220A to define a first vehicle group.

At 220N, Software content to be provided to vehicles in the first group is received. In some embodiments, this corresponds to an edge network node receiving software content to be provided to the vehicles. Further, and some embodiments, this corresponds to an edge network node along a route of the vehicles in the first vehicle group receiving the software content.

At 230N, the software content is sent to the first vehicle, and at 240N, an indication of the availability of the software content at the first vehicle is sent to the second vehicle.

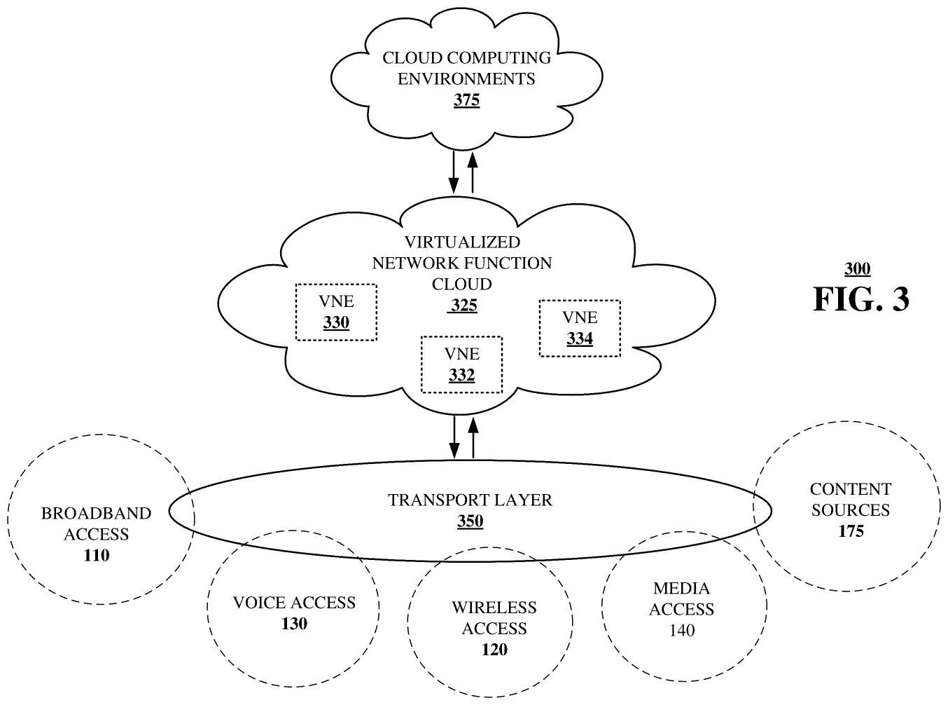

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part content distribution among peers.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage. Although virtual network functions have been described in the context of 3GPP network function virtualization (e.g., NFV and NFVI), the various embodiments described herein are not limited in this respect. For example, the various embodiments described herein may employ non-3GPP network function virtualization.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, dynamic host configuration protocol (DHCP) servers, system architecture evolution (SAE), mobility management entity (MME) gateways, access and mobility management function (AMF), user plane function (UPF), broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

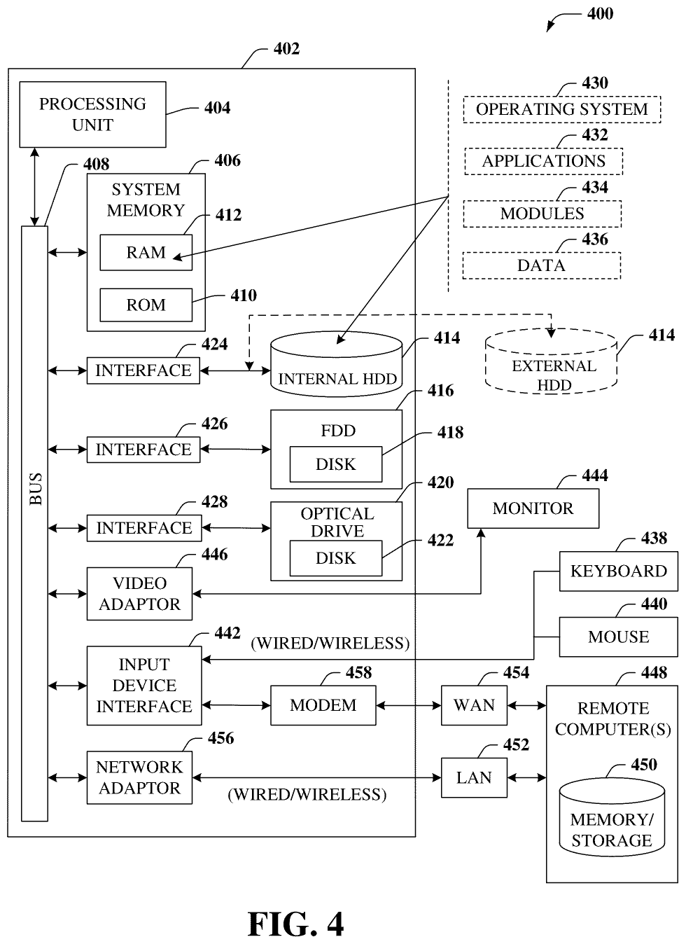

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part content distribution among peers.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

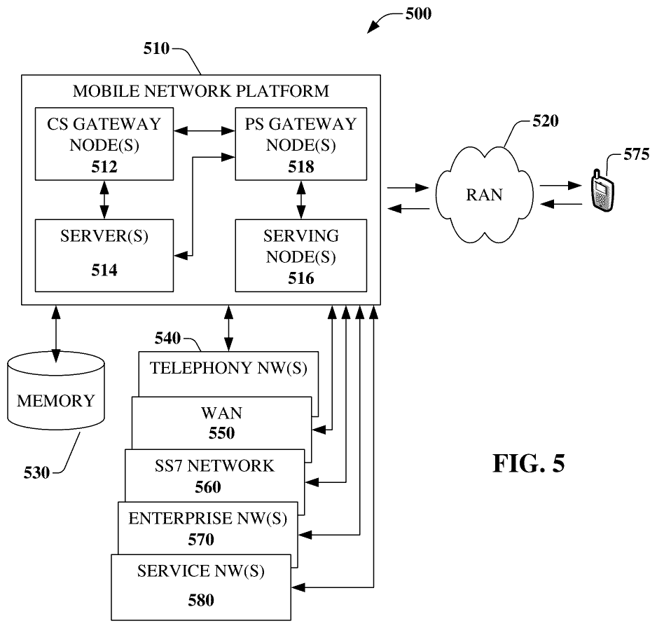

Turning now to FIG. 5, an embodiment 500 of a mobile network platform 510 is shown that is an example of network elements 150, 152, 154, 156, and/or VNEs 330, 332, 334, etc. For example, platform 510 may be a network element in a 3G, 4G, 5G, or higher generation wireless access network and can facilitate in whole or in part content distribution among peers. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

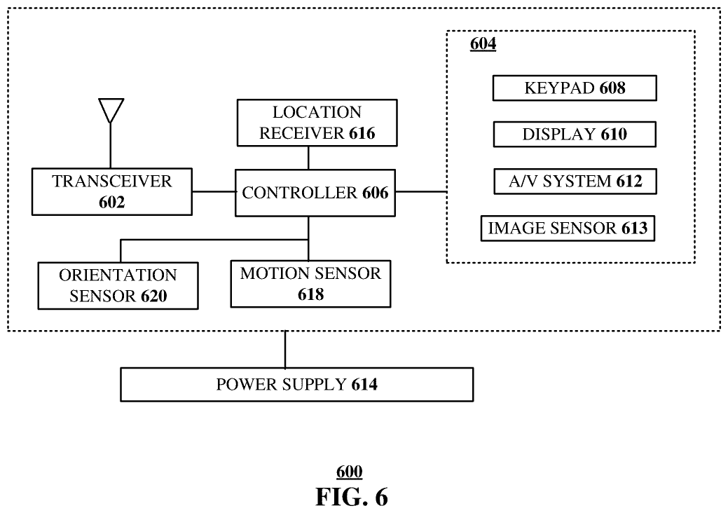

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part content distribution among peers.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, New Radio (NR), as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving a first software content;
sending the first software content to a first vehicle;
receiving a request for the first software content from a second vehicle; and
alerting the second vehicle that the first software content is available from the first vehicle.

2. The device of claim 1, wherein the operations further comprise positioning the first software content at an edge node of a communications network based on a location of the first vehicle.

3. The device of claim 1, wherein the operations further comprise positioning the first software content at an edge node of a communications network based on a historical demand from a plurality of vehicles.

4. The device of claim 1, wherein the operations further comprise determining that the first vehicle and the second vehicle are members of a first group.

5. The device of claim 1, wherein the operations further comprise:
determining that the first vehicle and the second vehicle are members of a first fleet, and
positioning the first software content at an edge node based on a future location of vehicles in the first fleet.

6. The device of claim 1, wherein the operations further comprise determining that the first vehicle and the second vehicle have a trusted relationship, and wherein the alerting the second vehicle that the first software content is available from the first vehicle is in response to the determining that the first vehicle and the second vehicle have the trusted relationship.

7. A non-transitory machine-readable medium, comprising executable instructions that, when executed by a processing system including a processor, facilitate performance of operations, the operations comprising:
receiving, at a first vehicle, software from a communications network;
receiving, at the first vehicle, a first request for the software from a second vehicle; and
providing the software from the first vehicle to the second vehicle.

8. The non-transitory machine-readable medium of claim 7, wherein the receiving the software comprises receiving the software from an edge node in the communications network.

9. The non-transitory machine-readable medium of claim 7, wherein the operations further comprise determining that the first vehicle and the second vehicle are in a common group.

10. The non-transitory machine-readable medium of claim 7, wherein the operations further comprise:
determining that the first vehicle and the second vehicle are not in a common group; and
forming an ad hoc group including the first vehicle and the second vehicle.

11. The non-transitory machine-readable medium of claim 7, wherein the operations further comprise broadcasting, to additional vehicles in a vicinity of the first vehicle, an availability of the software at the first vehicle.

12. The non-transitory machine-readable medium of claim 7, wherein the operations further comprise providing the software from the first vehicle to a non-vehicular device for further distribution.

13. The non-transitory machine-readable medium of claim 7, wherein the first vehicle has a route known to the communications network and wherein the receiving the software from the communications network comprises receiving the software from a network node along the route.

14. The non-transitory machine-readable medium of claim 7, wherein the operations further comprise:
receiving, at the first vehicle, a second request for the software from a third vehicle;
determining that the third vehicle is not in a common group with the first vehicle;
determining that the third vehicle has a trusted relationship with the second vehicle; and
responsive to the determining that the third vehicle has the trusted relationship with the second vehicle, providing the software from the first vehicle to the third vehicle.

15. The non-transitory machine-readable medium of claim 14, wherein the determining that the third vehicle has the trusted relationship with the second vehicle comprises receiving, from the second vehicle, an indication of the trusted relationship.

16. The non-transitory machine-readable medium of claim 14, wherein the determining that the third vehicle has the trusted relationship with the second vehicle comprises receiving, from the communications network, an indication of the trusted relationship.

17. A method, comprising:
storing, by a processing system including a processor, a first vehicle ID corresponding to a first vehicle and a second vehicle ID corresponding to a second vehicle in a record of a vehicle group database, wherein the record defines a first vehicle group;
receiving, by the processing system, a software content to be provided to vehicles in the first vehicle group;
sending, by the processing system, the software content to the first vehicle; and
sending, by the processing system, to the second vehicle, an indication of availability of the software content at the first vehicle.

18. The method of claim 17, further comprising:
determining, by the processing system, a route of the first vehicle; and
pre-positioning, by the processing system, the software content at a network node along the route of the first vehicle.

19. The method of claim 17, further comprising:
receiving, by the processing system, a request for the software content from a third vehicle not in the first vehicle group;
determining, by the processing system, that the first vehicle and the third vehicle have a trusted relationship; and
providing, by the processing system, the software content to the third vehicle.

20. The method of claim 19, wherein the determining that the first vehicle and the third vehicle have the trusted relationship comprises retrieving information from a vehicle trusted relationships database.
